(19) United States
(12) Patent Application Publication
(10) Pub. No.: US 2008/0118160 A1
(43) Pub. Date: May 22, 2008

(54) SYSTEM AND METHOD FOR BROWSING AN IMAGE DATABASE

(75) Inventors: Lixin Fan, Tampere (FI); Timo Pylvanainen, Tampere (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/562,547

(22) Filed: Nov. 22, 2006

(51) Int. Cl. G06K 9/62

(52) U.S. Cl. 382/225

(57) ABSTRACT

Systems and methods for organization and browsing a set of images allow a user to find and identify desired images. A collection of images (e.g., stored in an image database) may be organized using a tree or pyramid hierarchy such that each level of the hierarchy represents a finer level of similarity between images in an image cluster. In one arrangement, images are stored as leaf nodes and each ascendant node of the leaf nodes represents a cluster to which the images belong. Each ascendant node may include an animation image representing the set of images belonging to the cluster. A user may browse an image database by identifying and accessing clusters of images that are progressively more refined. A hybrid browsing method and system may also be used wherein images may be displayed simultaneously with the animation images to which they correspond.

### FIELD OF ART

The invention relates generally to a method and system for browsing images.

### BACKGROUND

Digital imaging has captured a wide audience due to the quality and flexibility of the output (i.e., digital pictures). As a result, digital imaging has been incorporated into a variety of devices and systems to make products more attractive with the added functionality. For example, many mobile phones include digital camera features allowing a user to take and store a photo in their phone. With the ease of capturing digital photos using such devices, the number of images stored in a database may expand quickly. In many image browsing systems, users must then sequentially scroll through the images to find a desired image. Such a process may absorb a significant amount of time, especially if the image database is large. The time needed to find an image may further be increased when using small displays, low resolutions and/or constrained input interfaces. In some systems, images may be organized according to name, date taken and/or size. However, users would need to memorize these attributes of a desired image to find the image in a large image database.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

A method and system for organization and browsing images using a coarse-to-fine organizational structure allows a user to locate images efficiently. An image database, e.g., stored in a mobile device, may be organized according to a pyramid or tree structure. In one or more configurations, the pyramid or tree structure may represent a hierarchical organization scheme. The structure may organize the images into one or more clusters, wherein each cluster provides a different level of refinement. For example, an image may be clustered into a first set or cluster of images based on two parameters. The image may then be further clustered into a second set or cluster based on the previous two parameters and a third parameter. As such, while the image belongs to both the first and second clusters, the second set or cluster would be more a refined grouping than the first set or cluster. Further, the second set or cluster may be considered a nested or child cluster of the first cluster. Each cluster or group may include an image animation file that stores an animation visually representing the images belonging to that cluster or group. In one example, an animated image may cycle through each of the images belonging to the cluster. The animations allow a user to visually determine which group his or her desired image belongs to. The use of animations and hierarchical clustering of images allows users browsing large image databases on a device with display screens of limited size to effectively and efficiently navigate through the database to locate a desired image.

According to another aspect, images may be clustered by determining a similarity score between each pair of images in a set of images. The similarity score may be derived based on a feature extraction process and a feature matching method. For example, the feature extraction process may include partitioning each image in an image set into multiple multi-scale patches. Once partitioned, the image may be analyzed to determine feature components from each patch and for each scale. Feature components may include shape, texture and color. Using the extracted feature components, images may be compared with one another to determine a similarity score. The similarity scores of each image pair may then be subjected to a graph cut technique to generate two or more clusters of images.

According to yet another aspect, a user may browse an image database using a hybrid image browsing interface. In a hybrid interface, animations corresponding to image clusters may be displayed in different portions of the display. The images belonging to the clusters may also be displayed in still another portion of the display. The user is thus able to either sequentially browse through the list of images displayed or navigate through the image database using the image animations.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a mobile terminal on which one or more aspects described herein may be implemented.

FIGS. 2A-2C illustrate a series of user interfaces corresponding to an image browsing function according to one or more aspects described herein.

FIG. 3 illustrates a structure for organizing images according to one or more aspects described herein.

FIG. 4 illustrates a navigation process through an image data organization structure according to one or more aspects described herein.

FIG. 5 is a flowchart illustrating a method for organizing a plurality of images according to one or more aspects described herein.

FIG. 6 is a flowchart illustrating a method for browsing an image database according to one or more aspects described herein.

FIG. 7 illustrates an image browsing sequence using a hybrid browsing interface according to one or more aspects described herein.

FIG. 8 is a flowchart illustrating a method for browsing an image database using a hybrid interface according to one or more aspects described herein.

FIG. 9 illustrates the construction of an animation based on child animations according to one or more aspects described herein.

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

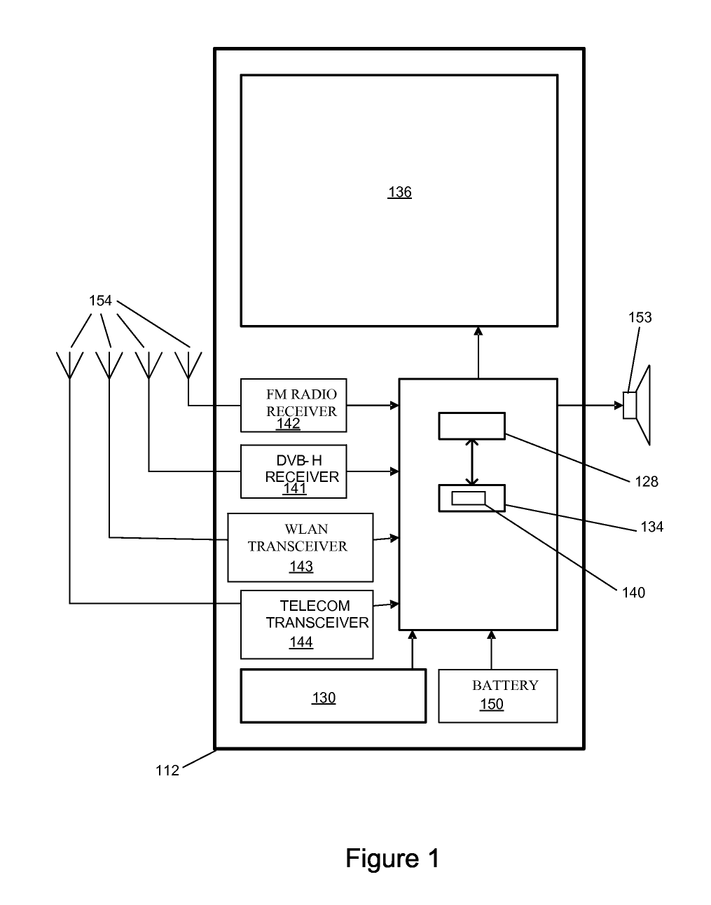

FIG. 1 illustrates a block diagram of a terminal including processor 128 connected to user interface 130, memory 134 and/or other storage, and display 136. Mobile terminal 112 may also include battery 150, speaker 152 and antennas 154. User interface 130 may further include a keypad, touch screen, voice interface, one or more arrow keys, joy-stick, data glove, mouse, roller ball, touch screen, or the like.

Computer executable instructions and data used by processor 128 and other components within mobile terminal 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile terminal 112 to perform various functions. Alternatively, some or all of mobile device 112 computer executable instructions may be embodied in hardware or firmware (not shown).

Mobile terminal 112 may be configured to receive, decode and process digital broadband broadcast transmissions that are based, for example, on the DVB standard, through a specific DVB receiver 141. The mobile device may also be provided with other types of receivers for digital broadband broadcast transmissions. Additionally, mobile terminal 112 may also be configured to receive, decode and process transmissions through FM/AM Radio receiver 142, WLAN transceiver 143, and telecommunications transceiver 144. Transceivers 143 and 144 may, alternatively, be separated into individual transmitter and receiver components (not shown). In one aspect of the invention, mobile terminal 112 may receive Radio Data System (RDS) messages.

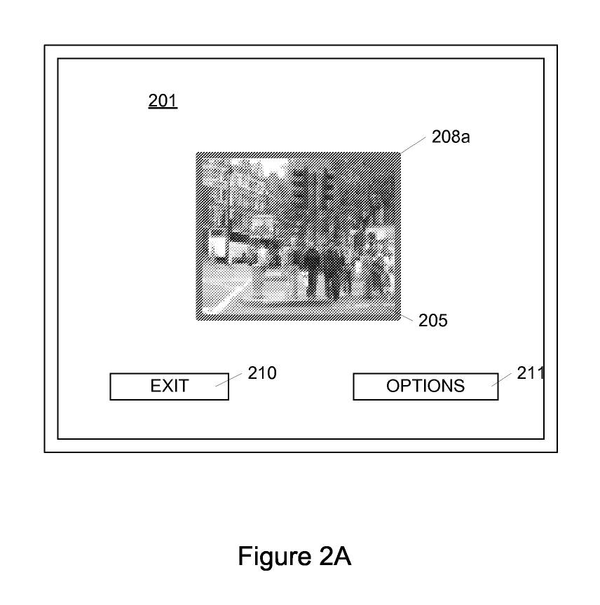

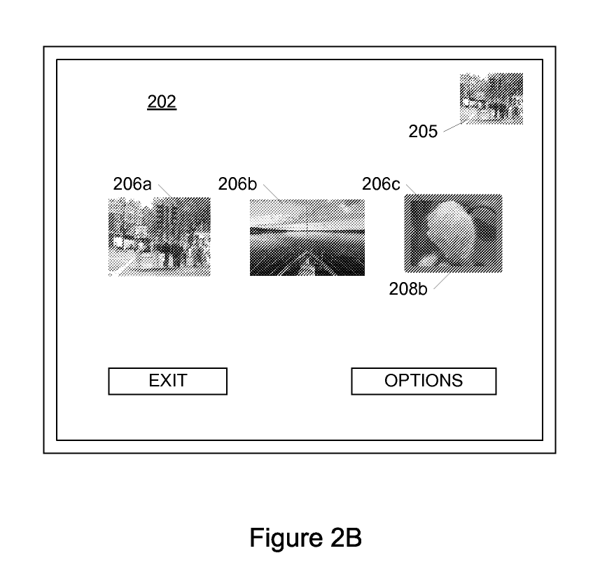

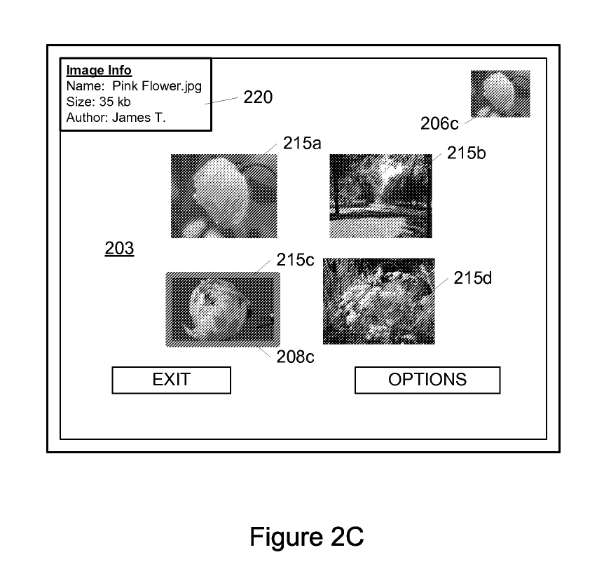

FIGS. 2A-2C illustrate a series of user interfaces corresponding to an image browsing function. In one or more instances, a user accessing an image browsing function on a device may be presented with user interface 201 of FIG. 2A, displaying an animation image 205 that may represent a database or set of images stored on a system or device. An animation image, as used herein, generally refers to an image that changes in appearance while being displayed. For example, an animation image may be stored in a variety of ways and formats. For example, animated images may be stored in a Graphics Interchange Format (GIF) image file that sequentially displays a series of images stored therein or associated therewith. To represent a database or plurality of images, animation image 205 may display a series of images corresponding to each of the images in the database. Interface 201 may further include selection indicator 208a that highlights animation image 205, indicating that a user's focus is currently on animation image 205. That is, indicator 208a is a highlighted band encircling the image. Additionally, interface 201 may provide options 210 and 211 that allow a user to exit the browsing function (option 210) or to browse using other methods (option 211).

Referring to FIG. 2B, if a user selects first animation image 205, a set of additional animation images 206a, 206b and 206c may be displayed in interface 202. Animation images 206 may each represent a grouping or set of images derived from the set of all images represented by animation image 205. For example, the images in a database may be divided and clustered according to a variety of factors including visual similarity. Image analysis and visual similarity is discussed in further detail below. Accordingly, each animation image 206a, 206b and 206c may display a series of images associated with its respective group. In one example, animation image 206c may be associated with a group of flower images while animation image 206b may be used to represent a set of landmark images. Further, animation image 206a may correspond to a group of city images. By visually inspecting each of animation images 206a, 206b and 206c, a user may be able to identify a category in which a desired image may be located. Using selection or focus indicator 208b, the user may select one of animation images 206a, 206b and 206c to access and view. For example, if a user is looking for a flower picture, he or she may browse the set or group of images represented by animation image 206c. Alternatively or additionally, user interface 202 may display the parent animation, i.e., animation 205, from which animations 206 descend in a portion of interface 202.

FIG. 2C illustrates user interface 203 displaying a set of images 215 associated with animation image 206c. That is, once a user selects animation image 206c in FIG. 2, the user may be presented with interface 203 including images 215. Interface 203 may further include information portion 220 that displays information about an image such as image 215c on which the user is focused (e.g., via selection indicator 208c). For example, information portion 220 may display a date on which image 215c was taken or stored, an author who took or provided image 215c and/or a size of the image file associated with image 215c. A variety of other information may also be provided in information portion 220.

By initially displaying animations representing sets of images, users may be able to better browse an image database on devices having smaller display screens or resolutions. Once the user has browsed down to a cluster having no more than a predefined number of images, the images may then be displayed on the screen. The predefined number of images may be set based on the display screen size, resolution and/or user preferences.

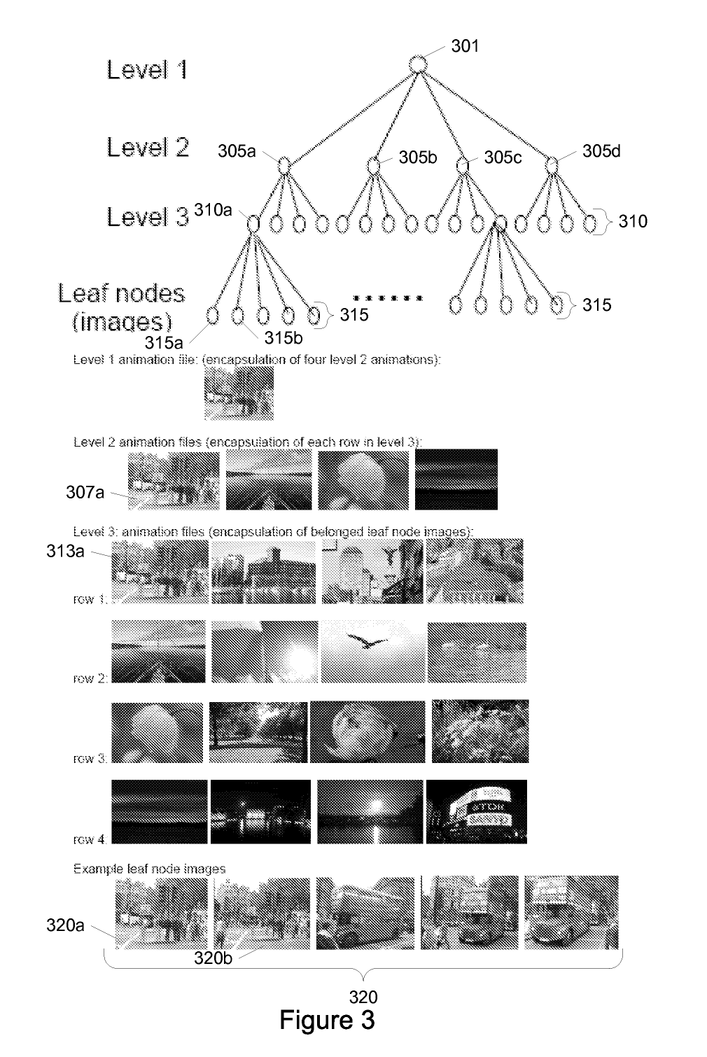

FIG. 3 illustrates an organizational structure for organizing and storing images to facilitate image browsing functions. The organizational structure may reflect a pyramidal or tree shape in that all images may be represented by a root image set node such as image set node 301. Additionally or alternatively, the organizational structure may be hierarchical. The images represented by root image set node 301 may then be divided into image sets represented by image set nodes 305 based on finer distinctions between images. The images may further be divided into even finer image sets, as represented by image set nodes 310. In particular, each of image set nodes 305 may be divided into two child image set nodes. Images may be stored as individual image nodes such as nodes 315 as leaf nodes (i.e., nodes without children) of the organizational structure and/or hierarchy. As such, an image represented by image node 315a, for example, may be a member of multiple image sets (i.e., the image sets corresponding to nodes 310a and 305a), each of the image sets representing a different degree of image grouping distinction. Generally, child image set nodes (e.g., nodes 310) reflect finer image grouping distinctions than their parent image set nodes (e.g., nodes 305). For example, an image represented by image node 315a may be a member of and descend from image set nodes 310a, 305a and 301, wherein image set node 310 is a subset of image set node 305a and image set node 305a is a subset of image set node 301. The clustering and grouping of images into image sets and subsets may be based on a variety of factors including visual similarity as is discussed in further detail below.

Each image set node 301, 305 and 310 may include an image animation that comprises images within the image set represented by each of nodes 301, 305 and 310. That is, images represented by image nodes descending from an image set node may be included in an image animation associated with that image set node. For example, image 320a may be included in an animation such as animation 313a associated with image set node 310a. Further, in one or more arrangements, animation 313a, when displayed to a user, may display images 320 in a sequential manner. In another example, image 320b corresponding to image node 315b may be included in image animation 307a corresponding to image set node 305a based on image node 315b's membership in the sub-tree and subset represented by image set node 305a.

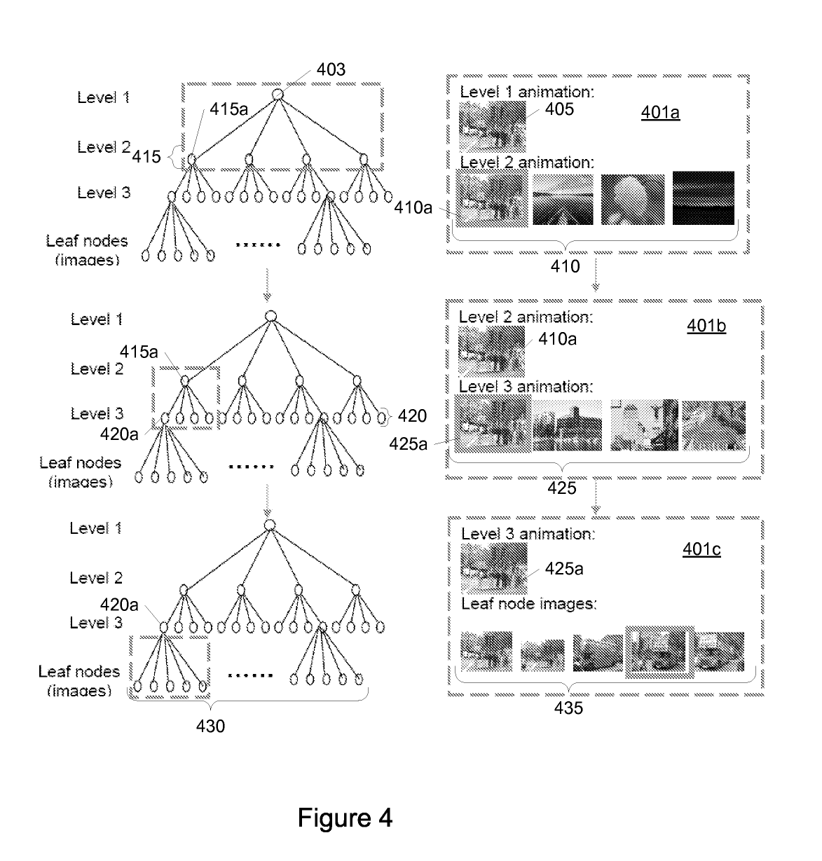

FIG. 4 illustrates a sequence of interface screens for browsing an image database and the corresponding navigation of the organizational structure (e.g., a hierarchy) representing the image database. In interface screen 401a, both image animation 405 corresponding to root node 403 and image animation 410 corresponding to image set nodes 415 are displayed. Accordingly, the underlying browsing function is initially focused on the first two levels of the tree structure. When a user selects one of image animations 410, e.g., image animation 410a, corresponding to image set nodes 415 on level 2 of the tree structure, the focus of the browsing function may shift to image set node 415a and its child image set nodes 420. Further, interface screen 401b may display selected image animation 410a as well as image animations 425 corresponding to child image set nodes 420. The user may then select image animations 425a from animations 425 changing the focus of the browsing function to node 420a and its child image nodes 430. Each of child image nodes 430 may include an image, e.g., one of images 435, that makes up animation 425a. Thus, interface screen 401c may display animation 425a and associated images 435. Various options may be available if a user selects one of images 435. For example, options may be provided to open a selected image in full size, transmit the selected image, delete the image and the like.

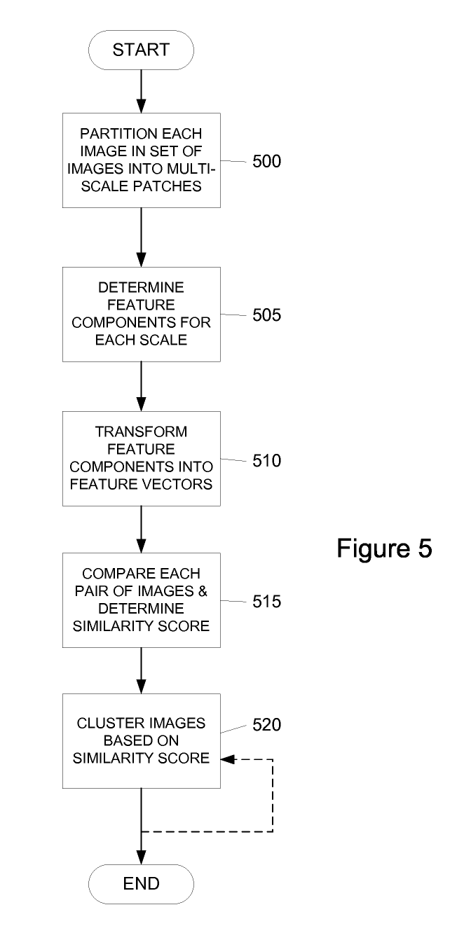

FIG. 5 is a flowchart illustrating a method for organizing a set of images. For example, a database of images stored in a mobile device like a mobile telephone or PDA may be organized according to aspects described in the following method. In step 500, each image in a set of images may be decomposed or partitioned into overlapping multi-scale patches. A patch may comprise a rectangular image region selected to coincide with high texture (e.g., high gradient of pixel intensity) image contents (e.g., corner points). Centered at each corner point, a number of overlapping patches of varying sizes (i.e. scales) may be selected. In one example, for images of 640×480 pixel resolution, 500 to 2000 such patches may be selected. The number of patches into which an image is decomposed or partitioned may depend on actual image contents. In step 505, each patch is then analyzed to determine and extract one or more feature components for each scale. Feature components that may be extracted from the image include shape, color and texture. For example, a set of Harr-like features may be used to characterize the shape of each image patch. A color feature component may correspond to a mean intensity determined over each patch in RGB channels for color images. Gray-scale images, on the other hand, may be assigned a color feature component of zero. A texture feature component may correspond to a mean variation of pixel intensities over each patch. Once the feature components have been extracted, each image is transformed into a set of feature vectors in step 510. A similarity score between two images is then determined using a cost function taking two sets of feature vectors as parameters in step 515. Further details of one possible feature extraction and matching technique may be found in U.S. patent application Ser. No. 11/452,761, filed Jun. 14, 2006. A variety of other methods of image similarity analysis may be used in addition to or in place of the above described methods.

In step 520, the images in the set of images may be divided or clustered into two groups based on the similarity score. In one or more configurations, this clustering or grouping of images may be performed by applying a graph cut technique, such as the normalized cut method described in Shi, J. and J. Malik, “Normalized Cuts and Image Segmentation,” Int. Conf. Computer Vision and Pattern Recognition, San Juan, Puerto Rico, June 1997. Step 520 may be repeated in an iterative manner such that the set of images may be further clustered into nested groups. For example, a set of images may initially be clustered into a first group and a second group based on similarity scores. The clustering process may then repeat dividing the first group into a third group and a fourth group. The third group and fourth group may be nested within the first group to represent a relationship between the images of each of the third group and fourth group. Ultimately, all images in the set of images are related based on a master or root group (i.e., the entire set) from which each of the clusters are formed. The nested clusters may be assigned to nodes in a tree-like structure as shown in FIG. 3.

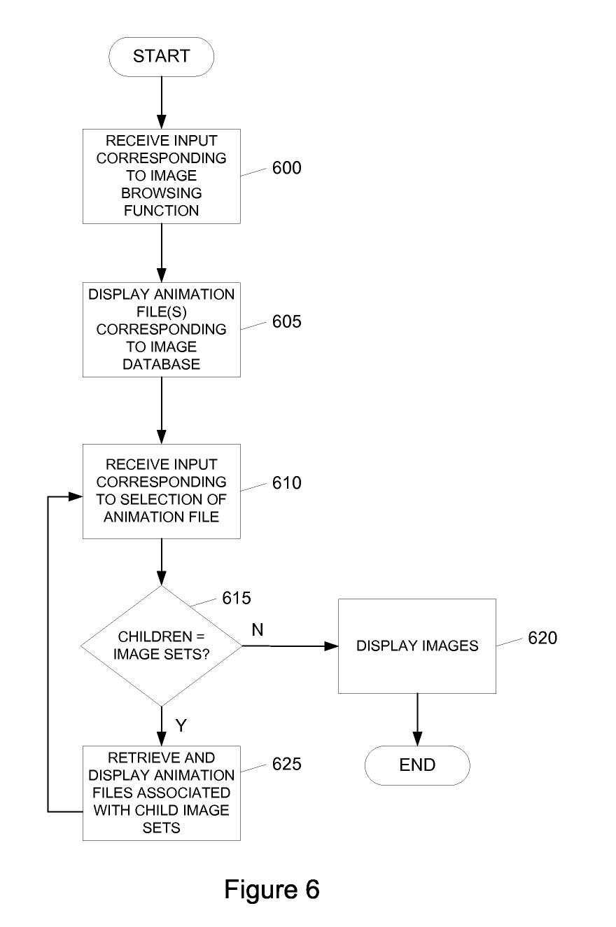

FIG. 6 is a flowchart illustrating a method for browsing an image database organized according to a pyramid scheme. In step 600, a device or system may receive input from a user corresponding to a desire to access an image browsing function. For example, a user may select a menu option on a mobile terminal to view images stored on the terminal. In response to the user input, the device or system may display an animation corresponding to an image set node of an image database in step 605. In one or more arrangements, when a user accesses the browsing function, the device or system may display the image animation corresponding to the root image set node of the image dataset. In step 610, the device or system may receive user input corresponding to a selection of a displayed animation. In response to the user selection of the animation, the device or system may determine whether children of the image set node corresponding to the selected animation constitute image nodes or image set nodes in step 615. One method of determining whether a node corresponds to an image node or an image set node is to determine whether the image animation associated therewith corresponds to a set of images or a single image. Alternatively or additionally, each node may include an indicator or flag identifying the node as an image node or an image set node. If, in step 615, it is determined that the child node or nodes corresponds to image nodes, the images associated with those child nodes may be displayed by the device or system in step 620.

If, however, it is determined that the child node or nodes corresponds to image set nodes, the image animations associated with those child nodes may be retrieved and displayed by the device or system in step 625. In one or more configurations, each of the image animations associated with the child nodes may include a subset of the images in the animation associated with the child node's parent. The method may then revert to step 610 where a user may make selections to further browse the database.

Thus, using a browsing technique based on a hierarchical organization scheme as illustrated in FIG. 6, users may be able to efficiently and effectively locate desired images. In situations where a device stores a substantial number of images and includes a small display screen, other browsing techniques may require a user to scroll through each of the images in the database before arriving at the desired image. Browsing using a hierarchical organization scheme allows users to navigate to a relevant image cluster or subset of images before beginning to view or scroll through individual images.

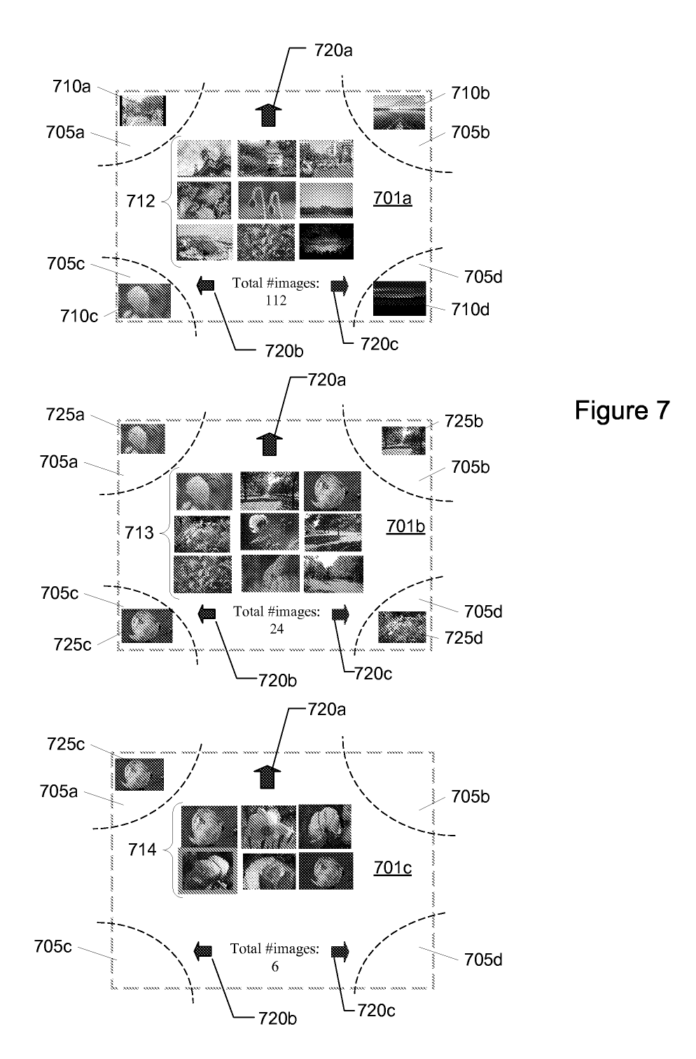

FIG. 7 illustrates a series of user interfaces 701a, 701b and 701c displaying a hybrid browsing function. User interface 701a includes multiple portions 705 displaying multiple animations 710 associated with multiple image sets. Interface 701a may further display images 712 associated with each of multiple animations 710. Options 720a, 720b and 720c allow for a user to scroll and view additional images (not shown) associated with image animations 710. For example options 720b and 720c may allow a user to scroll through pages of images associated with animations 710. Option 720a, on the other hand, may allow a user to navigate back to a previous interface. In one or more arrangements, if a user selects image animation 710c and image animation 710c corresponds to an image set having one or more image subsets, portions 705 may be populated with image animations 725 representing those subsets in interface 701b. Further, if a user selects one of image animations 725, e.g., image animation 725c, and image animation 725c is not associated with any child image sets, images 714 included in image animation 725c may be displayed in interface 701c. Image animation 725c may further be displayed in one of portions 705 to identify the set or cluster to which images 714 belong.

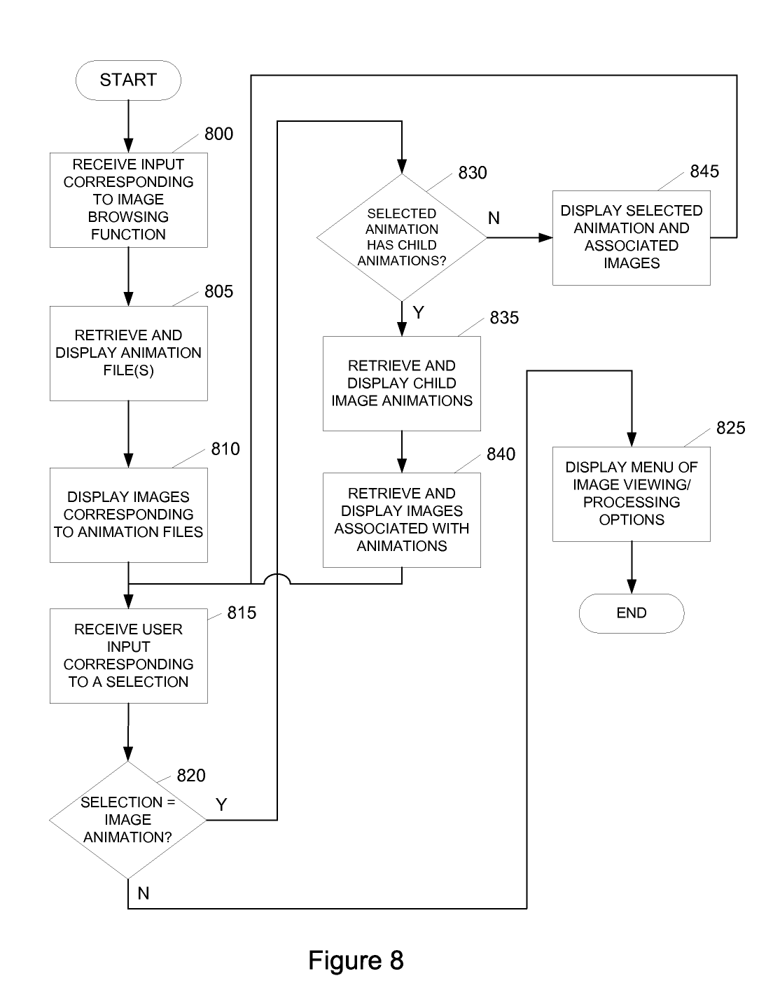

FIG. 8 is a flowchart illustrating a method for browsing an image database using a hybrid interface. In step 800, an image browsing system may receive user input corresponding to an activation of a hybrid browsing function. In response to the input, the system may retrieve and display a set of one or more image animations representing one or more clusters of images in an image database in step 805. Each of the one or more animations may be displayed in a different portion (e.g., portions 705 of FIG. 7) of the browsing interface. In step 810, images that are members of the clusters represented by the displayed one or more image animations may be displayed in another portion of the interface. For example, each of the animations may be displayed in a different corner of the interface while the images associated with those animations may be displayed in a central portion of the interface. The browsing system may further receive user input corresponding to a selection of one of the images or image animations in step 815. A determination may be made in step 820 as to whether the input corresponds to an image selection or an image animation selection. If the selection is an image selection, a menu of image viewing and processing options may be provided to the user in step 825.

If, however, the selection corresponds to an image animation selection, the system may determine whether the selected image animation includes child image animations or child images in step 830. If the image animation includes child image animations, the child image animations may be displayed in various portions of the interface in step 835. In one or more configurations, image animations might only be displayed in predefined areas of the interface. As such, when a user selects an image animation having child image animations, the previously displayed image animations may be replaced by the child image animations. Further, in step 840, images belonging to the one or more clusters associated with the child image animations may be displayed in the interface as well. The process may then revert back to step 815 where a user may make further browsing selections from the displayed images and image animations.

If, on the other hand, the selected image animation includes child images rather than child image animations, the system may display the selected image animation in a first portion of the interface and the images included in the selected image animation in a second portion of the interface in step 845. Such an interface configuration may allow a user to identify the cluster or image animation to which the displayed images belong. The system may then return to step 815 to receive further browsing selection input.

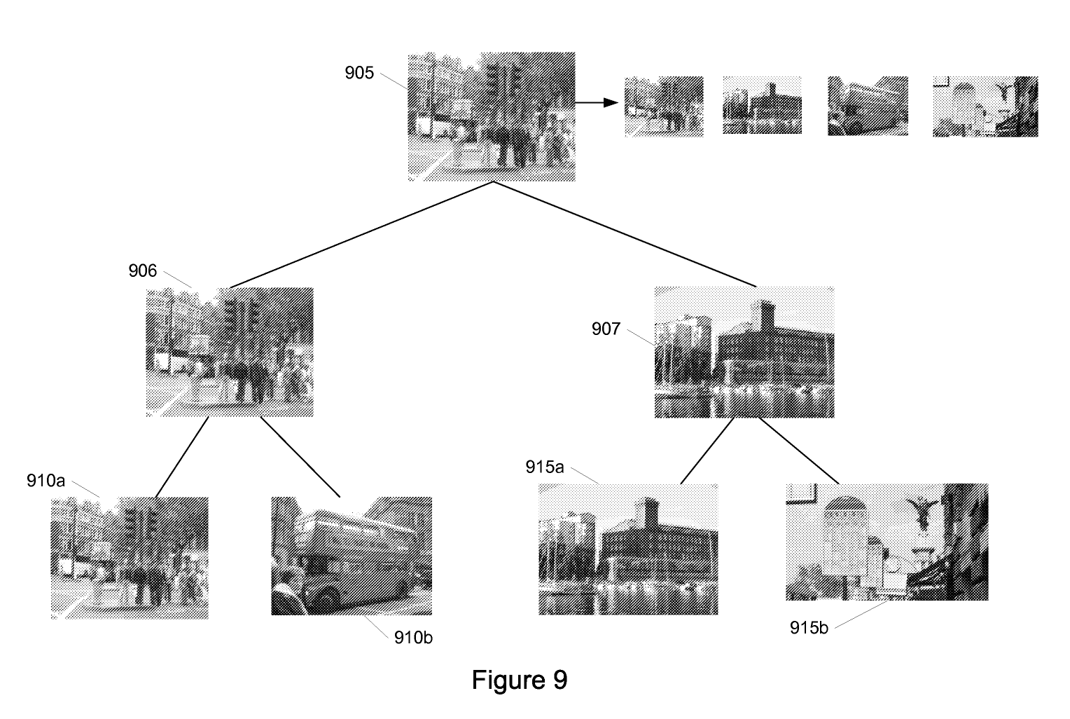

FIG. 9 illustrates a manner in which an animation corresponding to an image set having one or more image subsets may be generated. For example, animation 905 may have two child animations 906 and 907. Each of child animation 906 and 907 may include images such as images 910 and images 915. According to one or more configurations, parent animation 905 may be generated by alternating or interleaving images of image sets 910 and 915. That is, parent animation 905 may display image 910a as a first image, 915a as a second image, 910b as a third image and 915b as a fourth image. A variety of other animation construction methods may be used.

Although the methods and system described herein relate to the use of image animations to represent clusters or sets of images, other indicators may also be used. For example, each cluster may be represented by an alphanumeric code identifying a position in the hierarchy to which the cluster corresponds. Alternatively, each cluster or node in the organization structure may be represented by an image selected from the cluster or images.

Additionally, the methods and features recited herein may further be implemented through any number of computer readable mediums that are able to store computer readable instructions. Examples of computer readable mediums that may be used include RAM, ROM, EEPROM, flash memory or other memory technology, CD-ROM, DVD or other optical disk storage, magnetic cassettes, magnetic tape, magnetic storage and the like.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method comprising:
extracting a first feature component from a first image of a plurality of images;
extracting a second feature component from a second image of the plurality of images;
determining a similarity score based on a comparison of the first feature component and the second feature component; and
clustering the first image and the second image in a first cluster of an image hierarchy based on the similarity score.

2. The method of claim 1, wherein clustering the first image and the second image in the first cluster includes applying a graph cut technique.

3. The method of claim 1, wherein the first cluster is represented by a first animation image.

4. The method of claim 3, further comprising clustering a third image and a fourth image in a second cluster, wherein the second cluster is represented by a second animation image different from the first animation image.

5. The method of claim 3, wherein the first image animation includes a series of images to be displayed, the series of images including the first image and the second image.

6. The method of claim 1, wherein the first feature component includes at least one of a color feature, a texture feature and a shape feature.

7. The method of claim 1, wherein extracting the first feature component from the first image includes:
partitioning the first image into a plurality of multi-scale patches; and
extracting the first feature component from each of the multi-scale patches.

8. The method of claim 1, further comprising:
clustering the first image into a first sub-cluster of the first cluster; and
clustering the second image into a second sub-cluster of the first cluster.

9. A method comprising:
receiving, at a mobile terminal, a first user input corresponding to an image browsing function;
displaying, on the mobile terminal, a first indicator visually representing a first set of images, wherein the first set of images are grouped together based on a first degree of similarity;
receiving, at the mobile terminal, user input corresponding to a first selection of the first indicator;
determining whether the first indicator is associated with a child indicator, wherein the child indicator represents a second set of images grouped together based on a second degree of similarity, the second set of images being a subset of the first set of images; and
in response to determining that the first indicator is associated with the child indicator, displaying the child indicator.

10. The method of claim 9, wherein the first indicator is an image animation.

11. The method of claim 9, further comprising, in response to determining that the first indicator does not include the child indicator, displaying the first set of images.

12. The method of claim 9, wherein a similarly between each pair of images in the first set of images is determined using a feature extraction process.

13. The method of claim 12, wherein the feature extraction process includes:
partitioning each of the first set of images into multi-scale patches; and
determining at least one feature component from each of the multi-scale patches of each image.

14. The method of claim 9, wherein the second level of similarity is greater than the first level of similarity.

15. A device, comprising:
a display;
a processor; and
memory storing computer executable instruction that, when executed by the processor, cause the system to perform a method comprising:
receiving a first user input corresponding to an image browsing function;
displaying, on the display, a first indicator representing a first set of images, wherein the first set of images are grouped together based on a first degree of similarity;
receiving user input corresponding to a first selection of the first indicator;
determining whether the first indicator is associated with a child indicator, wherein the child indicator represents a second set of images grouped together based on a second degree of similarity, the second set of images being a subset of the first set of images; and
in response to determining that the first indicator is associated with the indicator, displaying the child indicator.

16. The device of claim 15, wherein a similarly between each pair of images in the first set of images is determined using a feature extraction process.

17. The device of claim 16, wherein the feature extraction process includes:
partitioning each image of the first set of images into multi-scale patches; and
determining at least one feature component from each of the multi-scale patches of each image.

18. The device of claim 16, wherein the first indicator includes an image animation.

19. The device of claim 15, wherein the device is a mobile communication device.

20. A method comprising:
receiving a first user input corresponding to an image browsing function;
displaying a first indicator in a first portion of a display interface, wherein the indicator corresponds to a first set of images;
displaying a second indicator in a second portion of the display interface, wherein the second indicator corresponds to a second set of images different from the first set of images, wherein the first set of images and the second set of images are subsets of an image database; and
displaying the first set of images and the second set of images in a third portion of the display interface.

21. The method of claim 20, further comprising:
receiving a user selection;
determining whether the user selection corresponds to the first indicator; and
in response to determining that the user selection corresponds to the first image animation, determining whether the first indicator is associated with a child indicator; and
in response to determining that the first indicator is associated with the child indicator, replacing the first indicator with the child indicator in the first portion of the display interface.

22. The method of claim 21, further comprising replacing, in the third portion of the display interface, the first set of images with a third set of images corresponding to the child indicator, wherein the third set of images is a subset of the first set of images.

23. A computer readable medium storing computer readable instructions that, when executed, cause a device to perform a method comprising:
receiving, at a mobile terminal, a first user input corresponding to an image browsing function;
displaying, on the mobile terminal, a first indicator representing a first set of images, wherein the first set of images are grouped together based on a first degree of similarity;
receiving, at the mobile terminal, user input corresponding to a first selection of the first indicator;
determining whether the first indicator is associated with a child indicator, wherein the child indicator represents a second set of images grouped together based on a second degree of similarity, the second set of images being a subset of the first set of images; and
in response to determining that the first indicator is associated with the child indicator, displaying the child indicator.

24. A computer readable medium storing computer readable instructions that, when executed, cause a device to perform a method comprising:
extracting a first feature component from a first image of a plurality of images;
extracting a second feature component from a second image of the plurality of images;
determining a similarity score based on a comparison of the first feature component and the second feature component; and
clustering the first image and the second image in a first cluster of an image hierarchy based on the similarity score.
